(19) United States
(12) Patent Application Publication
(10) Pub. No.: US 2007/0168285 A1
(43) Pub. Date: Jul. 19, 2007

(54) Systems and methods for neutralizing unauthorized attempts to monitor user activity

(76) Inventors: Jurijs Girtakovskis, Broomfield, CO (US); Jerome L. Schneider, Boulder, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/334,306

(22) Filed: Jan. 18, 2006

(51) Int. Cl. H04L 9/00

(52) U.S. Cl. 705/50

(57) ABSTRACT

Systems and methods for neutralizing unauthorized attempts to monitor user activity are described. In one embodiment, a system includes a detection module configured to detect an attempt to receive a message that is related to a protected application program. The system also includes a neutralization module configured to set a hook to neutralize the attempt.

### FIELD OF THE INVENTION

The invention relates generally to computer system management. In particular, but not by way of limitation, the invention relates to systems and methods for neutralizing unauthorized attempts to monitor user activity.

### BACKGROUND OF THE INVENTION

Personal computers and business computers can be vulnerable to attack by computer programs such as keyloggers, system monitors, browser hijackers, dialers, Trojans, spyware, and adware, which are typically referred to as “malware” or “pestware.” Some malware is highly malicious. Other malware is non-malicious but may nevertheless raise concerns with privacy or computer system performance. And yet other malware is actually desired by a user.

Malware typically operates to collect information about a person or an organization—often without the person's or the organization's knowledge. In some instances, malware also operates to report information that is collected. For example, a keylogger can monitor keyboard activity to collect information about a person or an organization. By monitoring the keyboard activity, the keylogger can capture and report out a sequence of keystrokes that represent sensitive information, such as a credit card number or a password.

Techniques are currently available for neutralizing malware. But as malware evolves, techniques for neutralizing malware should also evolve. Current techniques for neutralizing malware are not always satisfactory and will likely not be satisfactory in the future. In particular, current techniques for neutralizing malware often use digital signatures of known malware to scan files of a protected computer. However, it is often difficult to initially locate malware in order to generate digital signatures, particularly since malware can evolve. It would be desirable to neutralize new or evolving malware without relying on any digital signatures. Accordingly, systems and methods are needed to address the shortfalls of current techniques and to provide other new and innovative features.

### SUMMARY OF THE INVENTION

Embodiments of the invention include systems of managing malware. In one embodiment, a system includes a detection module configured to detect an attempt to receive a message that is related to a protected application program. The system also includes a neutralization module configured to set a hook to neutralize the attempt.

Embodiments of the invention also include computer-readable media. In one embodiment, a computer-readable medium includes executable instructions to intercept a message that would otherwise be received by a keylogger. The computer-readable medium also includes executable instructions to process the message so that the keylogger is rendered substantially ineffective.

Embodiments of the invention further include computer-implemented methods. In one embodiment, a computer-implemented method includes setting a hook to receive messages that are indicative of user activity. The computer-implemented method also includes scrambling at least one of the messages to neutralize a malware that is attempting to monitor the user activity.

Other embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a computer system that is implemented in accordance with an embodiment of the invention.

FIG. 2 illustrates a flowchart for neutralizing unauthorized attempts to monitor user activity, according to an embodiment of the invention.

FIG. 3 illustrates operation of an anti-malware module that is implemented in accordance with an embodiment of the invention.

FIG. 4 illustrates an anti-malware module that is implemented in accordance with another embodiment of the invention.

### DETAILED DESCRIPTION

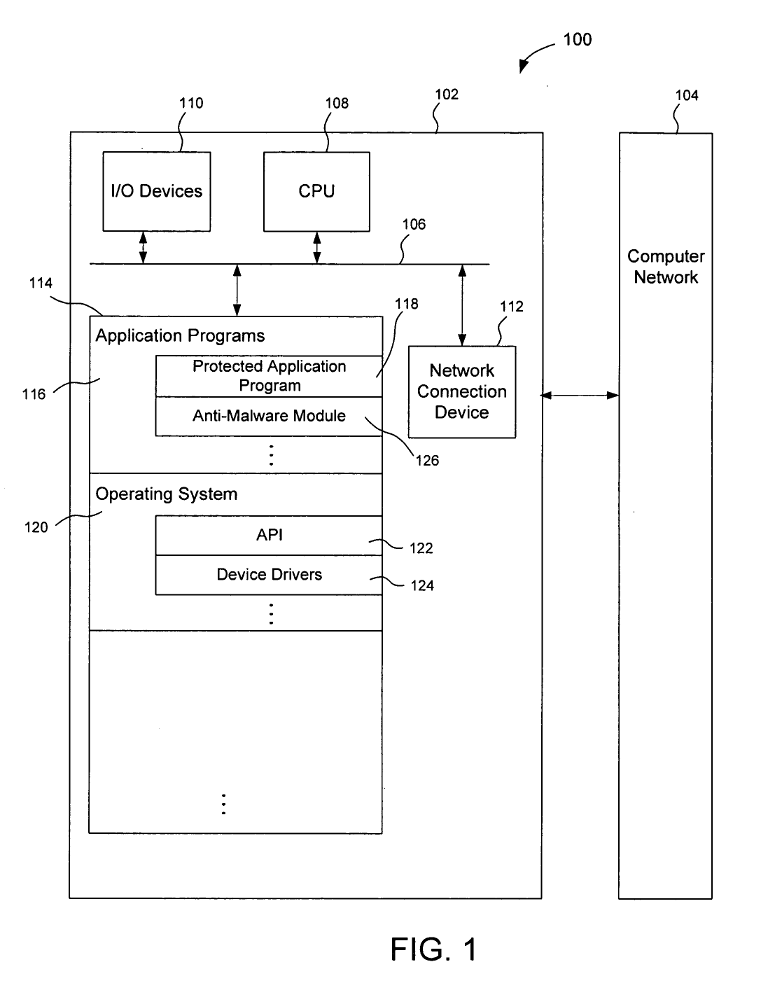

FIG. 1 illustrates a computer system 100 that is implemented in accordance with an embodiment of the invention. The computer system 100 includes at least one protected computer 102, which is connected to a computer network 104 via any wire or wireless transmission channel. In general, the protected computer 102 can be a client computer, a server computer, or any other device with data processing capability. Thus, for example, the protected computer 102 can be a desktop computer, a laptop computer, a handheld computer, a tablet computer, a personal digital assistant, a cellular telephone, a firewall, or a Web server. In the illustrated embodiment, the protected computer 102 is a client computer and includes a number of conventional client computer components that are connected via a bus 106. In particular, the protected computer 102 includes a central processing unit (“CPU”) 108 that is connected to a set of one or more input/output devices (“I/O devices”) 110, which can include, for example, a computer monitor, a keyboard, a mouse, a microphone, a speaker, and a video camera. Referring to FIG. 1, the CPU 108 is also connected to a network connection device 112 and a memory 114.

As illustrated in FIG. 1, the memory 114 stores a number of computer programs, including a set of application programs 116. The application programs 116 operate to perform various types of user-oriented operations. Referring to FIG. 1, the application programs 116 include a protected application program 118, which can be, for example, a Web browser that operates to establish communications with the computer network 104 via the network connection device 112. While not illustrated in FIG. 1, it is contemplated that additional protected application programs can be included, such as an electronic-mail (“e-mail”) program, a word processing program, a spreadsheet program, a database management program, a file transfer program, a desktop publishing program, a drawing program, a graphics program, an image editing program, and a media player.

Referring to FIG. 1, the application programs 116 also include an anti-malware module 126, which implements the operations described herein. As further described below, the anti-malware module 126 operates to manage a malware that can be present in the computer system 100. In particular, the malware can attempt to monitor user activity to collect information about a user of the protected computer 102. For example, the malware can be a keylogger that attempts to monitor keyboard activity to capture and report out a sequence of keystrokes. As another example, the malware can attempt to monitor mouse activity to capture and report out a sequence of mouse clicks or mouse movements. Advantageously, the anti-malware module 126 operates to neutralize the malware in accordance with an improved technique that does not require the use of any digital signatures. In such manner, the anti-malware module 126 is able to hinder operation of the malware even if the malware is new or evolving and might be undetected using digital signatures of known malware.

As illustrated in FIG. 1, the memory 114 also stores an operating system 120, which operates to perform various types of basic operations, such as data management, device management, job management, and task management. For example, the operating system 120 can be one available from Microsoft Corporation under the trademark WINDOWS, such as a WINDOWS 2000 operating system, a WINDOWS XP operating system, or a WINDOWS NT operating system. However, it is contemplated that the operating system 120 can be another type of operating system. As illustrated in FIG. 1, the operating system 120 includes an application programming interface (“API”) 122, which facilitates interaction between the operating system 120 and the application programs 116, and a set of device drivers 124, which facilitate interaction between the operating system 120 and the I/O devices 110.

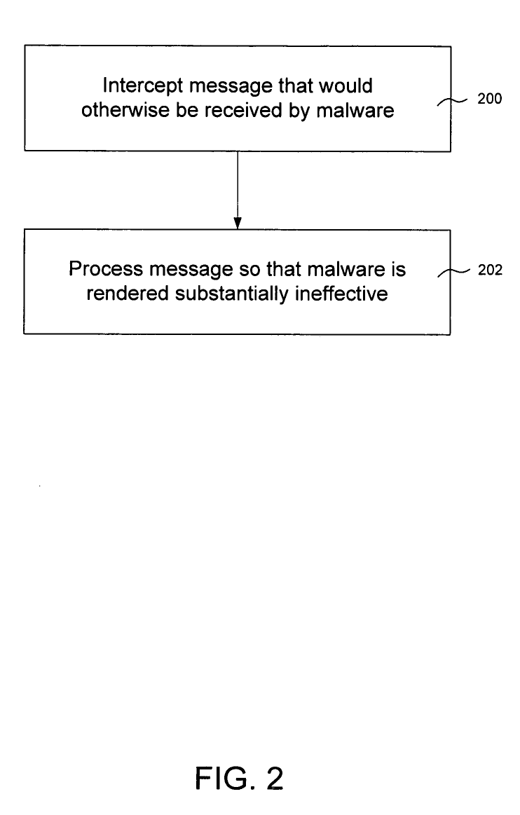

The foregoing provides a general overview of an embodiment of the invention. Attention next turns to FIG. 2, which illustrates a flowchart for neutralizing unauthorized attempts to monitor user activity, according to an embodiment of the invention.

The first operation illustrated in FIG. 2 is to intercept a message that would otherwise be received by a malware (block 200). In the illustrated embodiment, the message is intercepted by setting a hook. As can be appreciated, a hook typically refers to a mechanism by which a function can be notified of an event. For example, a hook can allow a function to be notified of an event that is related to user activity, such as keyboard activity or mouse activity. In order for a function to be notified of an event via a hook, the function is typically attached or coupled to the hook. The process of attaching a function to a hook is typically referred to as setting the hook. Different types of hooks can be defined according to different types of events that trigger operation of those hooks. For example, a keyboard hook can be defined to allow notification of keyboard activity, while a mouse hook can be defined to allow notification of mouse activity. In some instances, notification of an event can involve receiving a message that is indicative of that event.

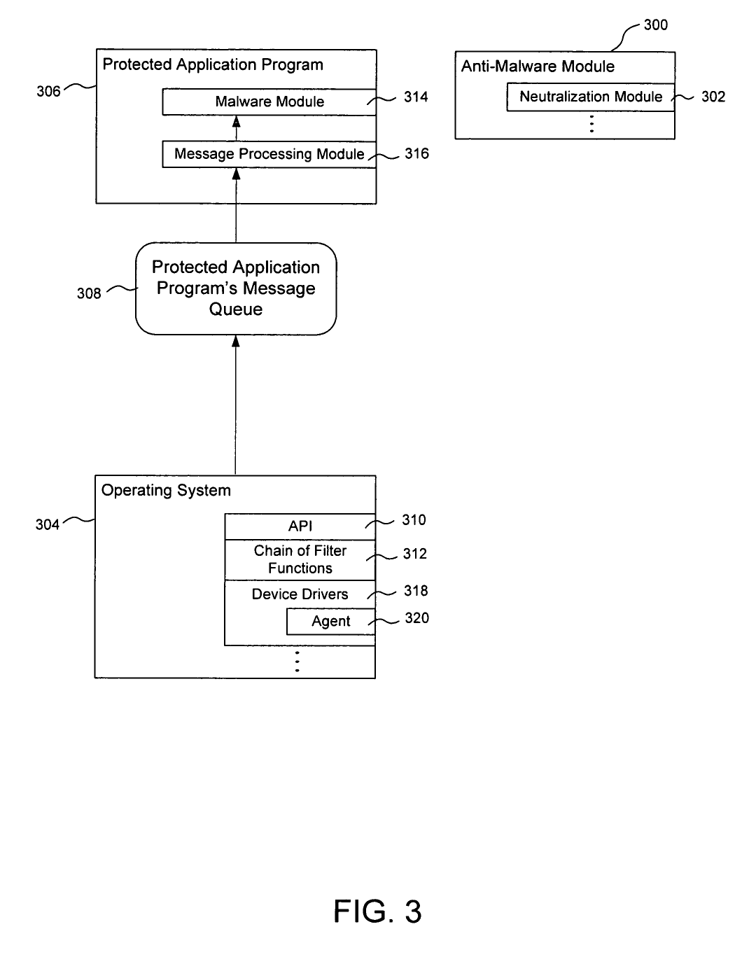

The illustrated embodiment can be further understood with reference to FIG. 3, which illustrates operation of an anti-malware module 300 that is implemented in accordance with an embodiment of the invention. In particular, FIG. 3 illustrates the operation of the anti-malware module 300 in the context of a typical interaction between an operating system 304 and a set of application programs, including a protected application program 306.

As illustrated in FIG. 3, the operating system 304 communicates with each application program via a separate message queue. In particular, when an event occurs during operation of the operating system 304, a message that is indicative of that event is distributed from the operating system 304 to an appropriate application program via that application program's message queue. Referring to FIG. 3, the operating system 304 maintains a message queue 308 for the protected application program 306, and the operating system 304 places messages that are related to the protected application program 306 in the message queue 308. For example, the messages can be indicative of keyboard activity related to operation of the protected application program 306. In order for the protected application program 306 to retrieve a message from the message queue 308, the protected application program 306 typically calls an API function, which is defined by an API 310 of the operating system 304. For example, in the case the operating system 304 is a WINDOWS operating system, the protected application program 306 can call a GetMessage API function to retrieve a message from the message queue 308.

Referring to FIG. 3, the API 310 defines a set of hooks, which can be used to receive messages that are related to the protected application program 306. In particular, setting a hook is typically performed at a user level by attaching a filter function to the hook. Once a filter function is attached to a hook, the filter function is notified of an event that triggers operation of the hook. For example, in the case of a keyboard hook, setting the keyboard hook can allow a filter function to receive a message that is indicative of keyboard activity from the message queue 308. The set of hooks defined by the API 310 can be used to provide a number of desirable functionalities, such as those related to hot keys. However, as further described below, the set of hooks can also be exploited by a malware that attempts to monitor user activity.

In the illustrated embodiment, setting a hook is performed by calling an API function, which is defined by the API 310. For example, in the case the operating system 304 is a WINDOWS operating system, setting the hook can be performed by calling a SetWindowsHookEx API function to attach a filter function to the hook. As can be appreciated, calling an API function to set a hook typically involves specifying a set of parameters, including a first parameter that indicates a type of hook to which a filter function is to be attached, a second parameter that indicates an address of the filter function, and a third parameter that indicates a scope with respect to which the filter function is to receive messages. With respect to the first parameter, the type of hook can be specified as, for example, a keyboard hook. With respect to the second parameter, the address of the filter function can be specified as, for example, the filter function's callback address. With respect to the third parameter, the scope can be specified as system wide so that the filter function can receive messages for all application programs, including the protected application program 306. Alternatively, the scope can be specified as being specific to the protected application program 306 so that the filter function can simply receive messages that are related to the protected application program 306.

In the event that multiple filter functions are attached to a hook, the operating system 304 maintains a chain of filter functions for the hook. Referring to FIG. 3, the operating system 304 maintains a chain of filter functions 312 for a particular hook, such as a keyboard hook, and, in this context, the process of attaching a filter function to the hook is typically referred to as installing the filter function in the chain of filter functions 312. The chain of filter functions 312 serves to track priorities assigned to multiple filter functions that are attached to the hook and can be implemented as, for example, a list of pointers that reference callback addresses of those filter functions. In the illustrated embodiment, the operating system 304 typically assigns a higher priority to a filter function that is installed with a scope specific to the protected application program 306 as compared with a filter function that is installed with a scope that is system wide. In the event that multiple filter functions are installed with the same scope, the operating system 304 typically assigns a higher priority to a filter function that is more recently installed as compared with a filter function that is installed earlier in time. When an event occurs that triggers operation of the hook, the operating system 304 calls a filter function having the highest priority in the chain of filter functions 312, namely one at the beginning of the chain of filter functions 312. Typically, this filter function is then responsible for calling a filter function having the next highest priority in the chain of filter functions 312. However, it is also contemplated that the operating system 304 can call the next filter function.

In the absence of the anti-malware module 300, messages that are distributed from the operating system 304 to the protected application program 306 can be vulnerable to monitoring by a malware, such as a keylogger. In particular, the malware can exploit the set of hooks defined by the API 310 to receive messages that are related to the protected application program 306. Referring to FIG. 3, the malware operates in conjunction with a malware module 314 that operates to maintain a log of user activity, and the malware sets a hook by attaching the malware module 314 to the hook. In particular, as illustrated in FIG. 3, the malware installs the malware module 314 as a filter function in the chain of filter functions 312. Typically, the malware installs the malware module 314 with a scope that is system wide. Referring to FIG. 3, installing the malware module 314 with such scope has the effect of injecting or mapping the malware module 314 onto a process address space of each application program that is currently executing, including the protected application program 306. However, it is also contemplated that the malware module 314 can be installed with a scope that is specific to the protected application program 306. In the illustrated embodiment, the malware module 314 resides in a dynamic-link library (“DLL”) file. However, it is contemplated that the malware module 314 can reside in any other appropriate file. Once the malware module 314 is installed in the chain of filter functions 312, the malware module 314 can receive messages that are related to the protected application program 306 from the message queue 308.

As illustrated in FIG. 3, the anti-malware module 300 operates to neutralize attempts by the malware to receive messages related to the protected application program 306. In the illustrated embodiment, the anti-malware module 300 includes a neutralization module 302, which operates to neutralize the attempts by exploiting the set of hooks defined by the API 310. Operation of the neutralization module 302 is triggered based on a particular event, such as in response to startup of the operating system 304 or the protected application program 306. It is also contemplated that the neutralization module 302 can operate on a periodic or some other basis.

Referring to FIG. 3, the neutralization module 302 operates in conjunction with a message processing module 316, and the neutralization module 302 sets the same hook with respect to which the malware module 314 is attached. In particular, the neutralization module 302, which serves as a master program, installs the message processing module 316 as a filter function in the chain of filter functions 312, which has the effect of injecting or mapping the message processing module 316 onto a process address space of the protected application program 306. In the illustrated embodiment, the message processing module 316 resides in a DLL file. However, it is contemplated that the message processing module 316 can reside in any other appropriate file.

In some instances, the neutralization module 302 can insert a reference to the message processing module 316 in an APP_INIT key in a registry file of the operating system 304, such that the operating system 304 will attempt to load the message processing module 316 for each application program that is currently executing. The neutralization module 302 can maintain information regarding which application program should be protected and can pass this information to the message processing module 316 using any suitable inter-process communication technique. Upon loading, the message processing module 316 can query the neutralization module 302 regarding whether protection is desired for a particular application program. If no protection is desired, the message processing module 316 can simply fail to load. However, if protection is desired, the message processing module 316 can load and can become installed as illustrated in FIG. 3.

By appropriately setting the hook, the neutralization module 302 installs the message processing module 316 so as to intercept messages that would otherwise be received by the malware module 314. In particular, the neutralization module 302 installs the message processing module 316 so as to have a higher priority in the chain of filter functions 312 as compared with the malware module 314. For example, since the malware module 314 is typically installed with a scope that is system wide, the neutralization module 302 can install the message processing module 316 with a scope that is specific to the protected application program 306. In the event that the malware module 314 is installed with a scope that is specific to the protected application program 306, the neutralization module 302 can reinstall the message processing module 316 with that scope on a periodic or some other basis. In such manner, the neutralization module 302 can ensure that the message processing module 316 is more recently installed than the malware module 314, thus maintaining the message processing module 316 at a higher priority in the chain of filter functions 312 as compared with the malware module 314. Alternatively, or in conjunction, the neutralization module 302 can install an agent 320 in a set of device drivers 318 of the operating system 304. Once installed, the message processing module 316 can register with the agent 320, which monitors further attempts to set the hook. Upon detecting a further attempt, the agent 320 can maintain the message processing module 316 at a higher priority in the chain of filter functions 312 by re-ordering the chain of filter functions 312 or by calling the message processing module 316 prior to other filter functions.

The second operation illustrated in FIG. 2 is to process the message so that the malware is rendered substantially ineffective (block 204). In the illustrated embodiment, the message is processed so as to achieve at least a partial reduction in the ability of the malware to carry out its intended operation or to achieve its intended objective. For example, the message can be processed to reduce the ability of the malware to monitor user activity based on the message.

Referring to FIG. 3, once the message processing module 316 is installed in the chain of filter functions 312, the message processing module 316 receives messages that are related to the protected application program 306 from the message queue 308. Upon receiving the messages, the message processing module 316 modifies at least some of the messages to produce modified messages, and the message processing module 316 then passes the modified messages to a next filter function in the chain of filter functions 312. For example, the message processing module 316 can scramble the messages so as to render them substantially unintelligible once received by the malware module 314. Scrambling the messages can be performed in accordance with any of a number of message transformation techniques, including those that are “one-way” and those that are “two-way.” As another example, the message processing module 316 can block the messages from being received by the malware module 314. Blocking the messages can be performed by, for example, omitting to pass the messages to a next filter function in the chain of filter functions 312 or omitting to call the next filter function to receive the messages.

In some instances, the message processing module 316 can perform an initial determination of whether a particular message should be modified. For example, the message processing module 316 can perform an initial determination of whether a particular message is indicative of a masked keyboard entry, such as a password entry that is masked by a set of asterisks or other special characters or that is otherwise rendered substantially unintelligible once displayed on a screen. In particular, the message processing module 316 can identify a currently focused window that is related to the protected application program 306 and can query a set of parameters of the focused window to perform such initial determination. In such manner, the message processing module 316 can selectively modify a particular message that represents sensitive information, while a remaining message need not be modified and can be simply passed on to a next filter function in the chain of filter functions 312. Such selective modification is desirable so as to neutralize the malware module 314 while reducing any adverse impact on computer system performance.

While operation of the anti-malware module 300 has been described with reference to setting a hook at a user level, it is contemplated that the anti-malware module 300 can operate in a similar manner by setting a hook at a driver level. In particular, setting a hook can be performed at a driver level by installing a filter driver in a chain of filter drivers. For example, in the case of a keyboard hook, setting the keyboard hook can be performed at a driver level to allow interception of messages that would otherwise be received by a keylogger. Similarly, other mechanisms of injecting computer code can be used in place of, or in combination with, setting a hook. Also, while the message processing module 316 is illustrated as being separate from the anti-malware module 300, it is contemplated that the message processing module 316 can be included in the anti-malware module 300.

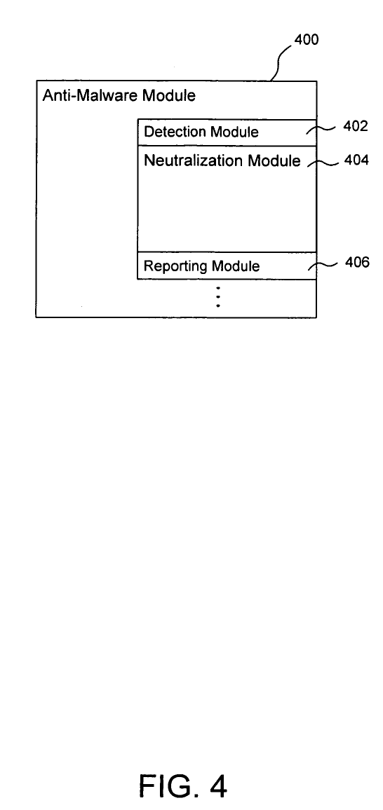

Turning next to FIG. 4, an anti-malware module 400 that is implemented in accordance with another embodiment of the invention is illustrated. As illustrated in FIG. 4, the anti-malware module 400 includes a number of sub-modules, including a detection module 402, a neutralization module 404, and a reporting module 406. As further described below, the detection module 402, the neutralization module 404, and the reporting module 406 operate to manage a malware that can be present on a protected computer.

Referring to FIG. 4, the detection module 402 monitors the protected computer to detect an attempt to receive a message that is related to a protected application program. In the illustrated embodiment, the detection module 402 detects the attempt based on determining that a hook is set with a scope that encompasses the protected application program. For example, the detection module 402 can determine that the hook is set with a scope that is system wide. As described previously, setting the hook can be performed by calling an API function, and the detection module 402 can determine the scope with respect to which the hook is set based on a set of parameters that are specified when calling the API function.

In connection with detecting the attempt, the detection module 402 identifies a suspicious module that is related to the attempt. In the illustrated embodiment, the detection module 402 identifies the suspicious module based on identifying the suspicious module as a filter function that is attached to the hook. For example, the detection module 402 can identify the suspicious module based on its callback address as specified when setting the hook.

Once the detection module 402 identifies the suspicious module, the detection module 402 next determines whether the suspicious module is allowed to receive the message. In the illustrated embodiment, the detection module 402 performs this determination based on a scope with respect to which the hook is set. For example, setting the hook with a scope that is system wide can be indicative of malware behavior, and the detection module 402 can determine that the suspicious module is not allowed to receive the message if the hook is set with such scope. It is also contemplated that the detection module 402 can perform this determination based on heuristic checks on the suspicious module. For example, the detection module 402 can determine whether the suspicious module is allowed to receive the message based on Internet or Hard Disc Drive (“HDD”) activities related to the suspicious module. It is further contemplated that the detection module 402 can request the protected application program or a user to confirm whether the suspicious module is allowed to receive the message.

If the detection module 402 determines that the suspicious module is not allowed to receive the message, the neutralization module 404 neutralizes the attempt to receive the message. In the illustrated embodiment, the neutralization module 404 neutralizes the attempt based on setting the same hook with respect to which the suspicious module is attached. For example, in a similar manner as described previously, the neutralization module 404 can operate in conjunction with a message processing module (not illustrated in FIG. 4), and the neutralization module 404 can attach the message processing module to the hook so as to intercept the message. It is also contemplated that the neutralization module 404 can neutralize the attempt based on de-attaching the suspicious module from the hook or preventing the suspicious module from being attached to the hook. For example, the neutralization module 404 can de-attach the suspicious module from the hook by calling an API function, such as an UnhookWindowsHookEx API function in the case of a WINDOWS operating system. It is further contemplated that the neutralization module 404 can remove the suspicious module from the protected computer or quarantine the suspicious module pending confirmation of whether the suspicious module is, in fact, a malware module.

Referring to FIG. 4, the reporting module 406 alerts a user of the protected computer about the attempt to receive the message. In the illustrated embodiment, the reporting module 406 also alerts the user about the suspicious module. In particular, once the detection module 402 identifies the suspicious module, the reporting module 406 alerts the user that the suspicious module is related to the attempt. It is also contemplated that the reporting module 406 can alert the user about the suspicious module pending confirmation of whether the suspicious module is, in fact, a malware module.

It is further contemplated that the reporting module 406 can report information related to the attempt to a remotely-located host computer that is connected to the protected computer. This information can identify the suspicious module as being related to the attempt and can include a representation of the suspicious module. This information as well as any additional relevant information can be analyzed at the host computer to confirm whether the suspicious module is, in fact, a malware module. If the suspicious module is confirmed to be a malware module, a new or updated set of digital signatures can be generated based on content within the suspicious module, and the new or updated set of digital signatures can be provided to the protected computer.

It should be recognized that the embodiments of the invention described above are provided by way of example, and various other embodiments are contemplated. For example, while the anti-malware module 126 is illustrated in FIG. 1 as included in the protected computer 102, it should be recognized that such configuration is not required in all implementations. In particular, it is contemplated that the anti-malware module 126, or a portion thereof, can be included in a remotely-located host computer that is connected to the protected computer 102.

An embodiment of the invention relates to a computer program product with a computer-readable medium including computer code or executable instructions thereon for performing a set of computer-implemented operations. The medium and computer code can be those specially designed and constructed for the purposes of the invention, or they can be of the kind well known and available to those having ordinary skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute computer code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as generated by a compiler, and files including higher-level code that are executed by a computer using an interpreter. For example, an embodiment of the invention can be implemented using Java, C++, or other object-oriented programming language and development tools. Additional examples of computer code include encrypted code and compressed code. Moreover, an embodiment of the invention can be downloaded as a computer program product, which can be transferred from a remotely-located host computer to a protected computer by way of data signals embodied in a carrier wave or other propagation medium via a transmission channel. Accordingly, as used herein, a carrier wave can be regarded as a computer-readable medium.

Another embodiment of the invention can be implemented using hardwired circuitry in place of, or in combination with, computer code. For example, with reference to FIG. 1, the anti-malware module 126 can be implemented using computer code, hardwired circuitry, or a combination thereof.

While the invention has been described with reference to some embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while the methods described herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A computer-implemented method, comprising:
setting a hook to receive messages that are indicative of user activity; and
scrambling at least one of the messages to neutralize a malware that is attempting to monitor the user activity.

2. The computer-implemented method of claim 1, wherein the hook corresponds to a keyboard hook, and the messages are indicative of keyboard activity.

3. The computer-implemented method of claim 1, wherein the messages are related to a protected application program, and the setting the hook includes setting the hook with a scope that is specific to the protected application program.

4. The computer-implemented method of claim 1, wherein the setting the hook includes installing a first filter function in the hook's chain of filter functions, and the scrambling the at least one of the messages is performed using the first filter function to produce a scrambled message.

5. The computer-implemented method of claim 4, wherein a second filter function is installed by the malware in the hook's chain of filter functions, and the second filter function receives the scrambled message.

6. The computer-implemented method of claim 5, further comprising:
maintaining the first filter function prior to the second filter function in the hook's chain of filter functions.

7. The computer-implemented method of claim 1, wherein the scrambling the at least one of the messages includes selectively scrambling the at least one of the messages based on determining that the at least one of the messages is indicative of a masked keyboard entry.

8. A computer-readable medium comprising executable instructions to:
intercept a message that would otherwise be received by a keylogger; and
process the message so that the keylogger is rendered substantially ineffective.

9. The computer-readable medium of claim 8, wherein the executable instructions to intercept the message include executable instructions to set a keyboard hook to intercept the message.

10. The computer-readable medium of claim 9, wherein the executable instructions to the set the keyboard hook include executable instructions to set the keyboard hook at a user level.

11. The computer-readable medium of claim 8, wherein the executable instructions to process the message include executable instructions to determine that the message is indicative of a masked keyboard entry.

12. The computer-readable medium of claim 8, wherein the executable instructions to process the message include executable instructions to modify the message to produce a modified message.

13. The computer-readable medium of claim 8, wherein the executable instructions to process the message include executable instructions to block the message from being received by the keylogger.

14. A system of managing malware, comprising:
a detection module configured to detect an attempt to receive a message that is related to a protected application program; and
a neutralization module configured to set a hook to neutralize the attempt.

15. The system of claim 14, wherein the message is indicative of keyboard activity, and the hook corresponds to a keyboard hook.

16. The system of claim 14, wherein the detection module is configured to:
identify a suspicious module that is related to the attempt; and
determine whether the suspicious module is allowed to receive the message.

17. The system of claim 16, wherein the neutralization module is configured to set the hook to intercept the message that would otherwise be received by the suspicious module.

18. The system of claim 17, further comprising:
a message processing module configured to process the message so that the suspicious module is rendered substantially ineffective.

19. The system of claim 18, wherein the message processing module is configured to process the message by modifying the message to produce a modified message.

20. The system of claim 18, wherein the message processing module is configured to process the message by blocking the message from being received by the suspicious module.
